(19) United States
(12) Patent Application Publication
(10) Pub. No.: US 2014/0167625 A1
(43) Pub. Date: Jun. 19, 2014

(54) ELECTRONIC CENSER

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/926,107

(22) Filed: Jun. 25, 2013

(30) Foreign Application Priority Data
Dec. 19, 2012 (TW) 101148287

(51) Int. Cl. F21V 33/00; H05B 37/02

(52) U.S. Cl. CPC F21V 33/0028; H05B 37/02
USPC 315/158

(57) ABSTRACT

An electronic censer includes a censer body, an incense branch mounted on the censer body, a sensor mounted on the censer body to sense a luminance of the environment, and a controller connecting the light source and the sensor. The incense branch includes a light guiding tube, a light source and a head member mounted on opposite ends of the light guiding tube, and light emitted from the light source guided by the light guiding tube and traveling through the head member to illuminate. When the light source is lighted, the sensor senses the luminance of the environment and a corresponding diction signal occurs in the sensor. The diction signal is transferred to the controller, and then the controller adjusts the luminance of the light source according to the diction signal.

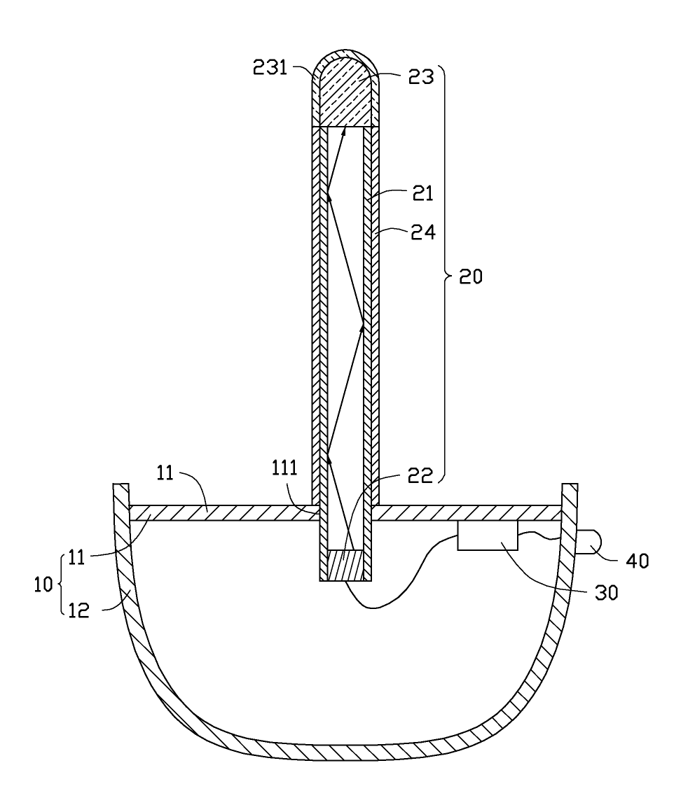

### BACKGROUND

1. Technical Field

The present disclosure generally relates to a censer, and particularly to an electronic censer.

2. Description of Related Art

Traditional censers are used for accommodating incenses, each of which mainly includes a rod made of bamboo and aromatic biotic materials coated on the rod. When the aromatic biotic materials are burned, they release large amounts of smoke. The burning incenses could ignite other articles to burn which may cause fire; furthermore, the released smoke not only pollutes the environment, but also is harmful to health.

Therefore, what is needed is to provide an electronic censer capable of overcoming the above shortcomings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The FIGURE is a cross sectional view of an electronic censer according to an exemplary embodiment of the present disclosure.

### DETAILED DESCRIPTION

Embodiments of an electronic censer will now be described in detail below and with reference to the drawings.

Referring to the figure, an electronic censer includes a censer body 10, an incense branch 20 mounted on the censer body 10, a controller 30 and a sensor 40.

The censer body 10 is a hollow container and includes a bottom cover 12 and a top cover 11 engaging with the bottom cover 12. An opening 111 is defined at a central of the top cover 11.

The incense branch 20 is elongated and a bottom end thereof extends through the opening 111 and mounted on the top cover 11. The incense branch 20 includes a light guiding tube 21, a light source 22, a head member 23, and a packaging layer 24. The light guiding tube 21 is a cylindrical, transparent tube. A bottom portion of the light guiding tube 21 is received in the censer body 10. A top portion of the light guiding tube 21 is beyond the top cover 11. The light source 22 is received in a bottom end of the light guiding tube 21 and located in the censer body 10. The head member 23 is mounted on a top end of the light guiding tube 21 and covers the top end of the light guiding tube 21. The head member 23 is transparent. In this embodiment, the head member 23 is made of glass or plastic. A red film 231 is coated on an outer surface of the head member 23. The packaging layer 24 covers an outer surface of the top portion of the light guiding tube 21. A top end of the packaging layer 24 abuts a bottom end of the red film 231. The packaging layer 24 is opaque.

Light emitted from the light source 22 is totally reflected by the packaging layer 24 and guided by the light guiding tube 21 to the head member 23, and travels through the head member 23 and the film 231 to illuminate. In this embodiment, the light source 22 is a light emitting diode (LED).

The controller 30 is mounted on an inner surface of the top cover 11. The sensor 40 is mounted on an outer side of the bottom cover 12 to sense a luminance of the environment. The controller 30 connects the light source 22 and the sensor 40.

When the light source 22 is lighted, the sensor 40 senses the luminance of the environment and a corresponding diction signal occurs in the sensor 40. The diction signal is transferred to the controller 30, and then the controller 30 adjusts the luminance of the light source 22 according to the diction signal. When the luminance of the environment is large enough, the controller 30 adjusts the light source 22 to emit light with a low luminance. In this state, light of the environment is reflected by the film 231 to simulate a candle light of the incense branch 20. When the luminance of the environment is low, the controller 30 adjusts the light source 22 to emit light with a high luminance. In this state, light of the light source 22 travels the head member 23 and the film 231 to simulate a candle light of the incense branch 20. In additional, the controller 30 can make the light source 22 flicker to simulate the candle light flickering.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic censer, comprising:
a censer body;
an incense branch mounted on the censer body, the incense branch comprising a light guiding tube, a light source and a head member mounted on opposite ends of the light guiding tube, and light emitted from the light source guided by the light guiding tube and traveling through the head member to illuminate;
a sensor mounted on the censer body to sense a luminance of the environment; and
a controller connecting the light source and the sensor;
wherein when the light source is lighted, the sensor senses the luminance of the environment and a corresponding diction signal occurs in the sensor, the diction signal is transferred to the controller, and then the controller adjusts the luminance of the light source according to the diction signal.

2. The electronic censer of claim 1, wherein the light guiding tube is a cylindrical, transparent tube.

3. The electronic censer of claim 2, wherein a packaging layer covers an outer surface of the light guiding tube.

4. The electronic censer of claim 3, wherein the packaging layer is opaque.

5. The electronic censer of claim 3, wherein the head member is mounted on a top end of the light guiding tube and covers the top end of the light guiding tube.

6. The electronic censer of claim 5, wherein the head member is transparent and made of glass or plastic.

7. The electronic censer of claim 5, wherein a red film is coated on an outer surface of the head member.

8. The electronic censer of claim 7, wherein a top end of the packaging layer abuts a bottom end of the red film.

9. The electronic censer of claim 1, wherein the censer body is a hollow container and includes a bottom cover and a top cover engaging with the bottom cover, and a bottom end of the incense branch extends through the top cover and is mounted on the top cover.

10. The electronic censer of claim 9, wherein the controller is mounted on an inner surface of the top cover.

11. The electronic censer of claim 9, wherein the sensor is mounted on an outer surface of the bottom cover.

12. An electronic censer, comprising:
an incense branch comprising a light guiding tube, a light source and a head member mounted on opposite ends of the light guiding tube, and a packaging layer formed on an outer surface of the light guiding tube, and light emitted from the light source totally reflected by the packaging layer and guided by the light guiding tube to travels through the head member to illuminate;
a sensor mounted on the censer body to sense a luminance of the environment; and
a controller connecting the light source and the sensor;
wherein when the light source is lighted, the sensor senses the luminance of the environment and a corresponding diction signal occurs in the sensor, the diction signal is transferred to the controller, and then the controller adjusts the luminance of the light source according to the diction signal.

13. The electronic censer of claim 12, wherein the light guiding tube is a transparent tube.

14. The electronic censer of claim 12, wherein the head member is mounted on a top end of the light guiding tube and covers the top end of the light guiding tube.

15. The electronic censer of claim 14, wherein a red film is coated on an outer surface of the head member.

16. The electronic censer of claim 15, wherein a top end of the packaging layer abuts a bottom end of the red film.

17. The electronic censer of claim 12, further comprising a censer body to support the incense branch.

18. The electronic censer of claim 17, wherein the censer body is a hollow container and includes a bottom cover and a top cover engaging with the bottom cover, and a bottom end of the incense branch extends through the top cover and is mounted on the top cover.

19. The electronic censer of claim 18, wherein the controller is mounted on an inner surface of the top cover.

20. The electronic censer of claim 18, wherein the sensor is mounted on an outer surface of the bottom cover.
